(19) United States
(12) Patent Application Publication
(10) Pub. No.: US 2005/0243814 A1
(43) Pub. Date: Nov. 3, 2005

(54) Method and system for an overlay management system

(75) Inventors: Thomas P. Bishop, Austin, TX (US); Robert A. Fabbio, Austin, TX (US)

Correspondence Address: TOLER & LARSON & ABEL L.L.P., 5000 PLAZA ON THE LAKE STE 265, AUSTIN, TX, 78746, US

(73) Assignee: VIEO, Inc.

(21) Appl. No.: 10/826,777

(22) Filed: Apr. 16, 2004

(51) Int. Cl. H04L 1/00

(52) U.S. Cl. 370/389; 370/230; 370/235

(57) ABSTRACT

Systems and methods are described which allow communications in an application infrastructure to be prioritized based on a variety of factors, including the component or application flow with which the communications are associated. A communication may be received and classified into one of a series of application flows. A management communication may be received from a management interface component over a management network and forwarded in a prioritized manner to an application infrastructure component in the application infrastructure. Similarly, a management communication may be received from an application infrastructure component in the application infrastructure in a prioritized manner and forwarded over a management infrastructure to a management interface component.

### CROSS-REFERENCE TO RELATED APPLICATION(S)

This application is related to U.S. patent application Ser. No. ______, entitled: “Method and System for Application-Aware Network Quality of Service” by Thomas Bishop et al., filed on ______, 2004 (Attorney Docket No. VIEO1220). All applications cited within this paragraph are assigned to the current assignee hereof and are fully incorporated herein by reference.

### FIELD OF THE INVENTION

The invention relates in general to methods and systems for managing and controlling application infrastructure components in an application infrastructure, and more particularly, to methods and systems for classifying and prioritizing management communications in an application infrastructure.

### BACKGROUND

In today's rapidly changing marketplace, disseminating information about the goods and services offered is important for businesses of all sizes. To accomplish this efficiently, and comparatively inexpensively, many businesses have set up application infrastructures, one example of which is a site on the World Wide Web. These sites provide information on the products or services the business provides, the size, structure, and location of the business; or any other type of information which the business may wish people to access.

As these sites grow increasingly complex, the application infrastructures by which these sites are accessed and on which these sites are based grow increasingly complex as well. To facilitate the implementation and efficiency of these application infrastructures, a mechanism by which an application infrastructure may be managed and controlled is desirable.

Managing and controlling an application infrastructure presents a long list of difficulties. Not the least of these difficulties is the delivery of communications pertaining to the management and control of the application infrastructure itself. In order to manage an application infrastructure, management and control communications must be routed to various destinations in the application infrastructure. Ironically however, in many cases the very problems trying to be resolved by these management and control solutions may prevent these management and control communications from being timely delivered or delivered at all. This presents a circular problem, the severity of the problem varies directly with the need for management and control communications, however, the more severe the problem the harder it is to guarantee delivery of these management and control communications.

Additionally, these same application infrastructure problems may cause relatively important application traffic to be bottled up, drastically reducing the application's efficiency and effectiveness. An example of such an application infrastructure problem may be a broadcast storm originating with a device in an application infrastructure running a relatively unimportant or underutilized application. In a typical application infrastructure, a broadcast storm of this type may cause network communication traffic throughout the entire application infrastructure to slow to a crawl, and in many cases this device would be unreachable through the network. Which begs the question, if something is unreachable, how may the offending device be quieted?

Part and parcel with these application infrastructure problems is the additional problem of application priority. Many times a relatively unimportant application will be communicating frequently while an important application may communicate less frequently. This may be problematic, as communications from the less important application may hinder communications to and from a relatively more important application.

Thus, a need exists for methods and systems which can monitor, classify, assess, and control management communications in an application infrastructure in order to prioritize and control the communications based upon the applications with which they are associated.

### SUMMARY

Systems and methods for classifying, controlling and prioritizing communications in an application infrastructure are disclosed. These systems and methods allow a communication to be associated with a particular component, application, or flow of application communications, and prioritized based on the component, application or application flow with which the communication is associated. These priorities may be assigned based on the relative bandwidth or connection dedicated to a particular component or application stream. Additionally, one of the applications or flows with which a communication may be associated may be a management stream. Importantly, these systems and methods may allow communications belonging to the management stream to be prioritized above other communications and routed directly to their intended destination.

In one embodiment, a communication in the application infrastructure is examined, the communication is classified as content data or management data and routed based on this classification.

In another embodiment, the packet is classified based on a network protocol, a source address, a destination address, a source port, or a destination port.

In still other embodiments, the packet is received from an application infrastructure component.

In yet another embodiment, classifying the packet is accomplished using a stream label mapping table.

In some embodiments, the packet is routed to a management interface component.

In other embodiments, the packet is routed over a management network infrastructure.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The use of the same reference symbols in different drawings indicates similar or identical items. The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 includes an illustration of a hardware configuration of a system for managing and controlling an application that runs in an application infrastructure.

FIG. 2 includes an illustration of a hardware configuration of the application management and control appliance in FIG. 1.

FIG. 3 includes an illustration of a hardware configuration of one of the management blades in FIG. 2.

FIG. 4 includes an illustration of a process flow diagram for a method of evaluating a communication and prioritizing the communication based on how it is classified during the evaluation.

FIG. 5 includes an illustration of a process flow diagram for a method of processing management communications.

FIG. 6 includes an illustration of a process flow diagram for a method of processing application infrastructure communications.

### DESCRIPTION OF THE PREFERRED EMBODIMENT(S)

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

Reference is now made in detail to the exemplary embodiments of the invention, examples of which are illustrated in the accompanying drawings. Wherever possible, the same reference numbers will be used throughout the drawings to refer to the same or like parts (elements).

A few terms are defined or clarified to aid in an understanding of the terms as used throughout the specification. The term “application infrastructure component” is intended to mean any part of an application infrastructure associated with an application. Application infrastructure components may be hardware, software, firmware, network, or virtual application infrastructure components. Many levels of abstraction are possible. For example, a server may be an application infrastructure component of a system, a CPU may be an application infrastructure component of the server, a register may be an application infrastructure component of the CPU, etc. For the purposes of this specification, application infrastructure component and resource are used interchangeably.

The term “application infrastructure topology” is intended to mean the interaction and coupling of components, devices, and application environments in a particular application infrastructure, or area of an application infrastructure.

The term “central management component” is intended to mean a management interface component that is capable of obtaining information from other management interface components, evaluating this information, and controlling or tuning an application infrastructure according to a specified set of goals. A control blade is an example of a central management component.

The term “component” is intended to mean any part of a managed and controlled application infrastructure, and may include all hardware, software, firmware, middleware, network, or virtual components associated with the managed and controlled application infrastructure. This term encompasses central management components, management interface components, application infrastructure components and the hardware, software and firmware which comprise each of them.

The term “device” is intended to mean a hardware component, including computers such as web servers, application servers and database servers, storage sub-networks, routers, load balancers, application middleware, or application infrastructure components, etc.

The term “local” is intended to mean a coupling of two components with no intervening management interface component. For example, if a device is local to a component, the device is coupled to the component, and network and other traffic may pass between the device and component without passing through an intervening management interface component. If a software component is local to a component, the software component may be resident on one or more computers, at least one of which is coupled to the component, where network or other traffic may pass between the component and the computer(s) without passing through an intervening management interface component.

The term “management interface component” is intended to mean a component in the flow of traffic on a network operable to obtain information about traffic and devices in the application infrastructure, send information about the components in the application infrastructure, analyze information regarding the application infrastructure, modify the behavior of components in the application infrastructure, or generate instructions and communications regarding the management and control of the application infrastructure. A management blade is an example of a management interface component.

The term “remote” is intended to mean one or more intervening management interface components lie between two specific components. For example, if a device is remote to a management interface component, network or other traffic between the device and the management interface component may be routed through one or more additional management interface components. If a software component is remote to a management interface component, the software component may be resident on one or more computers, where network or other traffic between the computer(s) and the management interface component may be routed through one or more additional management interface components.

As used herein, the terms “comprises,” “comprising,” “includes,” “including,” “has,” “having” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or unidirectionally coupled to each other. Coupling should be construed to include direct electrical connections and any one or more of intervening switches, resistors, capacitors, inductors, and the like between any two or more components.

To the extent not described herein, many details regarding specific networks, hardware, software, firmware components and acts are conventional and may be found in textbooks and other sources within the computer, information technology, and networking arts.

Before discussing embodiments of the present invention, a non-limiting, exemplary hardware architecture for using embodiments of the present invention is described. After reading this specification, skilled artisans will appreciate that many other hardware architectures can be used in carrying out embodiments described herein and to list every one would be nearly impossible.

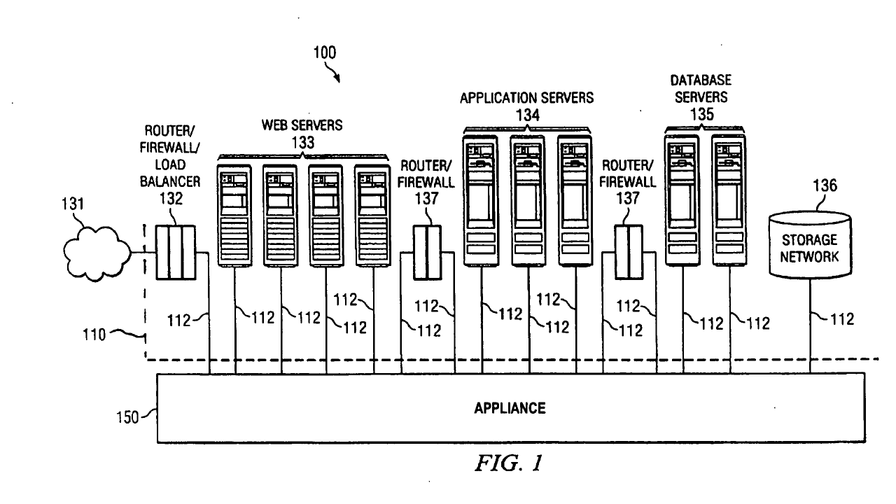

FIG. 1 includes a hardware diagram of a system 100. The system 100 includes an application infrastructure 110, which is the portion above the dashed line in FIG. 1. The application infrastructure 110 includes the Internet 131 or other network connection, which is coupled to a router/firewall/load balancer 132. The application infrastructure further includes Web servers 133, application servers 134, and database servers 135. Other computers may be part of the application infrastructure 110 but are not illustrated in FIG. 1. The application infrastructure 110 also includes network 112, storage network 136, and router/firewalls 137. Although not shown, other additional application infrastructure components may be used in place of or in addition to those application infrastructure components previously described. Each of the application infrastructure components 132-137 is bi-directionally coupled in parallel to appliance (apparatus) 150 via network 112. In the case of router/firewalls 137, both the inputs and outputs from such router/firewalls are connected to the appliance 150. Substantially all the traffic for application infrastructure components 132-137 in application infrastructure 110 is routed through the appliance 150 via network 112. Software agents may or may not be present on each of application infrastructure components 112 and 132-137. The software agents can allow the appliance 150 to monitor, control, or a combination thereof at least a part of any one or more of application infrastructure components 112 and 132-137. Note that in other embodiments, software agents may not be required in order for the appliance 150 to monitor or control the application infrastructure components.

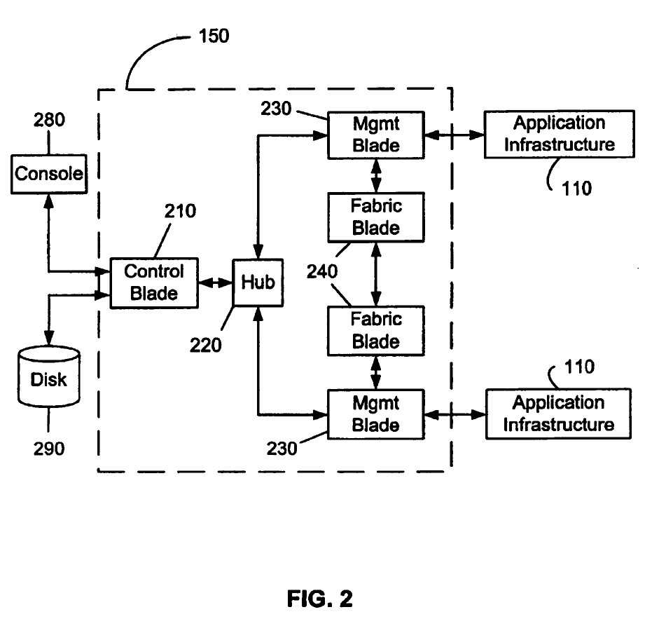

FIG. 2 includes a hardware depiction of appliance 150 and how it is connected to other components of the system. The console 280 and disk 290 are bi-directionally coupled to a control blade 210 within the appliance 150. The console 280 can allow an operator to communicate with the appliance 150. Disk 290 may include data collected from or used by the appliance 150. The appliance 150 includes a control blade 210, a hub 220, management blades 230, and fabric blades 240. The control blade 210 is bi-directionally coupled to a hub 220. The hub 220 is bi-directionally coupled to each management blade 230 within the appliance 150. Each management blade 230 is bi-directionally coupled to the application infrastructure 110 and fabric blades 240. Two or more of the fabric blades 240 may be bi-directionally coupled to one another.

Although not shown, other connections may be present and additional memory may be coupled to each of the components within appliance 150. Further, nearly any number of management blades 230 may be present. For example, the appliance 150 may include one or four management blades 230. When two or more management blades 230 are present, they may be connected to different parts of the application infrastructure 110. Similarly, any number of fabric blades 240 may be present and under the control of the management blades 230. In another embodiment, the control blade 210 and hub 220 may be located outside the appliance 150, and nearly any number of appliances 150 may be bi-directionally coupled to the hub 220 and under the control of control blade 210.

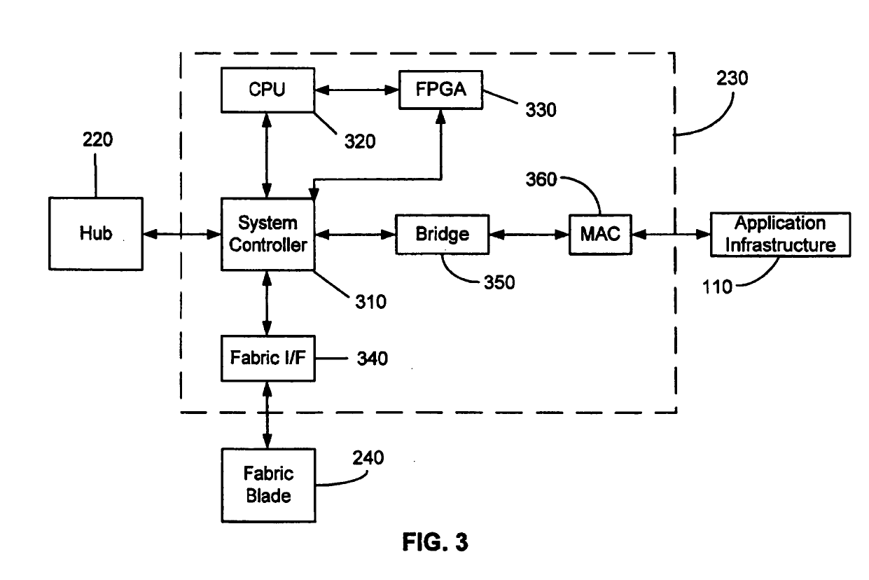

FIG. 3 includes an illustration of one of the management blades 230, which includes a system controller 310, central processing unit (“CPU”) 320, field programmable gate array (“FPGA”) 330, bridge 350, and fabric interface (“I/F”) 340, which in one embodiment includes a bridge. The system controller 310 is bi-directionally coupled to the hub 220. The CPU 320 and FPGA 330 are bi-directionally coupled to each other. The bridge 350 is bi-directionally coupled to a media access control (“MAC”) 360, which is bi-directionally coupled to the application infrastructure 110. The fabric I/F 340 is bi-directionally coupled to the fabric blade 240.

More than one of any or all components may be present within the management blade 230. For example, a plurality of bridges substantially identical to bridge 350 may be used and bi-directionally coupled to the system controller 310, and a plurality of MACs substantially identical to MAC 360 may be used and bi-directionally coupled to the bridge 350. Again, other connections may be made and memories (not shown) may be coupled to any of the components within the management blade 230. For example, content addressable memory, static random access memory, cache, first-in-first-out (“FIFO”) or other memories or any combination thereof may be bi-directionally coupled to FPGA 330.

The appliance 150 is an example of a data processing system. Memories within the appliance 150 or accessible by the appliance 150 can include media that can be read by system controller 310, CPU 320, or both. Therefore, each of those types of memories includes a data processing system readable medium.

Portions of the methods described herein may be implemented in suitable software code that may reside within or accessibly to the appliance 150. The instructions in an embodiment of the present invention may be contained on a data storage device, such as a hard disk, a direct access storage device (“DASD”) array, magnetic tape, floppy diskette, optical storage device, or other appropriate data processing system readable medium or storage device.

In an illustrative embodiment of the invention, the computer-executable instructions may be lines of assembly code or compiled C⁺⁺, Java, or other language code. Other architectures may be used. For example, the functions of the appliance 150 may be performed at least in part by another appliance substantially identical to appliance 150 or by a computer, such as any one or more illustrated in FIG. 1. Additionally, a computer program or its software components with such code may be embodied in more than one data processing system readable medium in more than one computer.

Communications between any of the components in FIGS. 1-3 may be accomplished using electronic, optical, radio-frequency, or other signals. When an operator is at a computer, the computer may convert the signals to a human understandable form when sending a communication to the operator and may convert input from a human to appropriate electronic, optical, radio-frequency, or other signals to be used by and one or more of the components.

Attention is now directed to methods and systems for managing and controlling communication flows in an application infrastructure and the utilization of specific resources by specific applications in an application infrastructure. These systems and methods may examine and classify a communication, and based upon this classification, prioritize the delivery of this communication. The classification may be based on a host of factors, including the application with which the communication is affiliated (including management traffic), the source or destination of the communication, and other factors, or any combination thereof. To classify the communication, these methods and systems may observe the traffic flowing across the network 112 by receiving a communication originating with, or intended for, a component in an application infrastructure and examining this communication. The communication may then be routed and prioritized based on this classification.

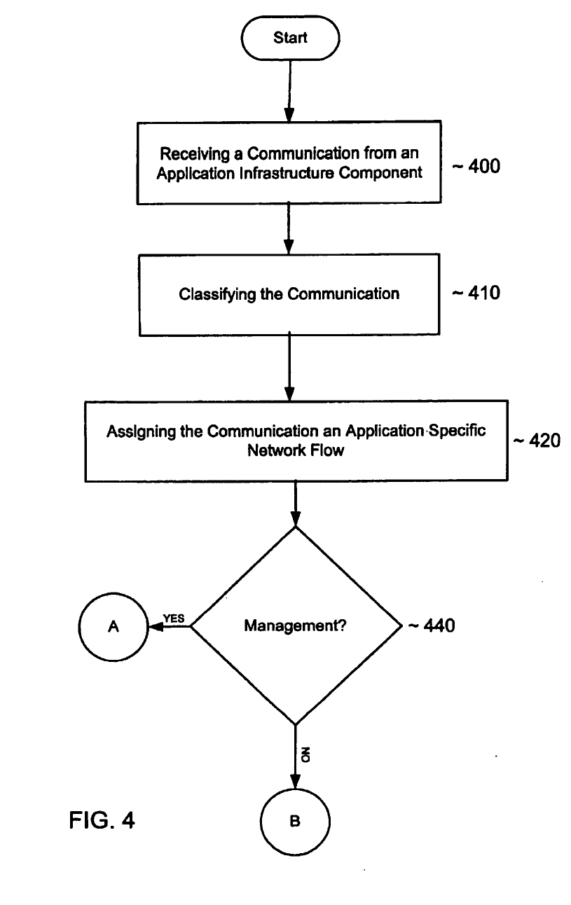

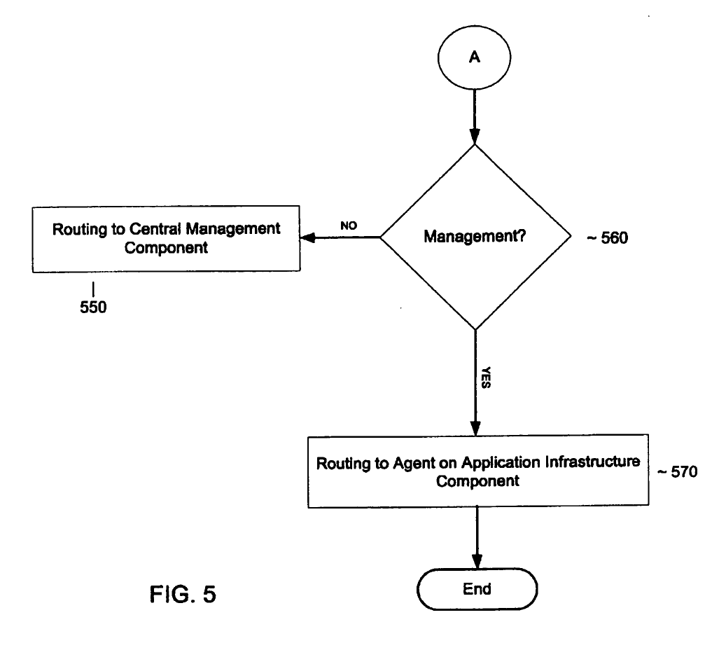

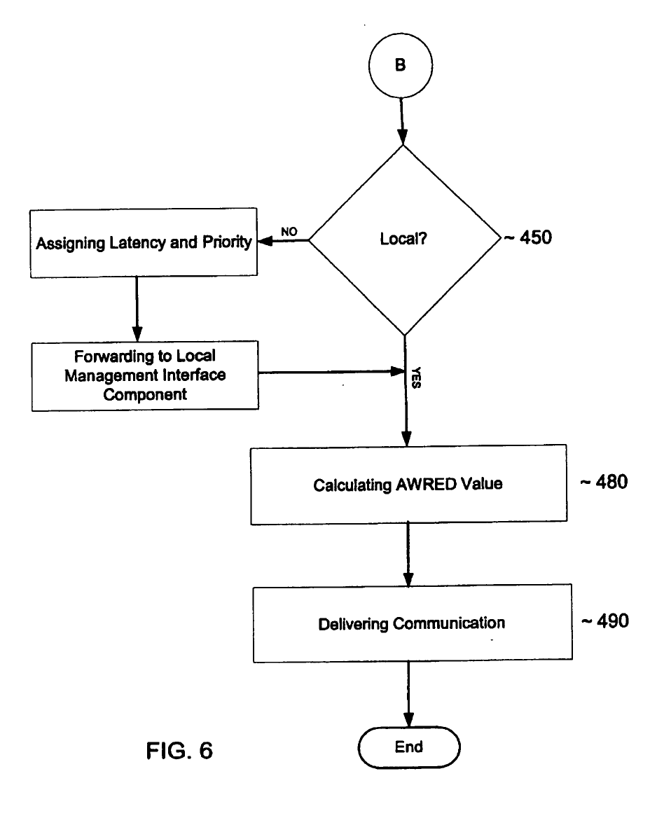

A software architecture for implementing systems and methods for classifying and prioritizing communications within an application infrastructure is illustrated in FIGS. 4-6. These systems and methods may include receiving a network or other communication from a component of the application infrastructure (block 400), classifying the communication (block 410), and based on this classification assigning the communication an application specific network flow (block 420). If the communication is management traffic (block 440), the communication is processed accordingly (as depicted in FIG. 5). Referring briefly to FIG. 6, if the communication is not management traffic, a determination is made whether the communication is intended for a local component (block 450). If the communication is intended for a remote application infrastructure component (“No” branch), the communication may be assigned a latency and a priority (block 460) and forwarded to a local management interface component (block 470). Once at a local management interface component, the communication may be assigned an application weighted early discard value (block 480) and delivered (block 490) to its intended destination. This exemplary, nonlimiting software architecture is described below in greater detail.

In order to classify and prioritize a communication in application infrastructure 110, management blade 230 receives a network or other communication from a component in application infrastructure 110 (block 400). Application infrastructure components in application infrastructure 110 may be coupled to management blade 230 and yet may not be directly connected to one another. Consequently, communications between application infrastructure components on different devices in application infrastructure 110 travel through management blade 230. Once communications arrive from an application infrastructure component in application infrastructure 110, this communication may be converted into packets by MAC 360 of management blade 230. In certain embodiments, these packets may conform to the Open System Interface (OSI) seven layer standard. In one particular embodiment, communications between components on application infrastructure 110 are assembled by MAC 360 into Transmission Control Protocol/Internet Protocol (“TCP/IP”) packets.

Once management blade 230 has received a communication, management blade 230 may classify this communication (block 410). In one embodiment, the communication received can be an IP packet and is classified by looking at the various layers of the incoming packet. The header of the received packet may be examined, and the packet classified based on the Internet Protocol (IP) being used by the packet. In some embodiments, the classification may entail differentiating between the TCP and UDP IP protocols. Classification of a received packet may also be based on the IP address of the source or destination of the packet, or the IP port of the source or destination of the packet. For example, a special IP address may be assigned a control blade 210 to perform management functions, and therefore, all packets associated with management traffic originating with control blade 210, or destined for control blade 210, contain this IP address in one or more layers. By examining this packet and detecting this special IP address, the determination may be made that the packet belongs to management traffic.

In certain associated embodiments, the classification of these packets by management blade 230 may be accomplished by FPGA 330. The classification may be aided by a tuple, which may be a combination of information from various layers of the packet. In one particular embodiment, a tuple that identifies a particular class of packets associated with a particular application specific network flow may be defined. The elements of this tuple (as may be stored by FPGA 330 on management blade 230) can consist of various fields which may be selected from the following possible fields:

| | Possible | | |
|---|---|---|---|
| Possible Field | Values | # Bits | Description |
| Port Group | 256 | [15:8] | Not used by table |
| | | [7:0] | 1 RAM (256 × 8 bit table) |
| Ethertype | 3 plus | [15:0] | 3 compare registers, 4 weights |
| | default | | |
| IP Source | 3 sets of | [31:8] | 3 compare registers selecting |
| Address | 256 plus | | 1.3 RAMs |
| | default | | |
| | | [7:0] | 3 RAMs (256 × 8 bit table each) |
| IP Dest Address | 3 sets of | [31:8] | 3 compare registers selecting |
| | 256 plus | | 1.3 RAMs |
| | default | | |
| | | [7:0] | 3 RAMs (256 × 8 bit table each) |
| IP Source Port | 15 plus | [15:0] | 15 compare registers, 16 |
| | default | | weights |
| IP Dest Port | 15 plus | [15:0] | 15 compare registers, 16 |
| | default | | weights |
| IP Protocol | 256 | [7:0] | 1 RAM (256 × 8 bit table) |
| IP Type of | 64 | [5:0] | 1 RAM (64 × 8 bit table) |
| Service | | | |
| Weight Mapping | 256 | [7:0] | 1 RAM (256 × 13 bit table) |

For example, a tuple including a particular IP source port, a particular IP destination port and a particular protocol may be defined and associated with a particular applications specific network flow. If information is extracted from various layers of an incoming packet which matches the information in this tuple, the incoming packet may in turn be associated with that particular application specific network flow.

Monitoring logic within management blade 230 may read specific fields from the first 128 bytes of each packet and record that information in its memory. After reading this specification, skilled artisans will recognize that more detailed information may be added to the tuple to further qualify packets as belonging to a particular managed and controlled application stream, particularly as it affects transaction prioritization. Packet processing on management blade 230 may include collecting dynamic traffic information on specific tuples. Traffic counts (number of bytes and number of packets) for each type of tuple may be kept and provided as gauges to analyze logic on management blade 230.

After the packet is classified (block 410), this classification may then be used to assign the packet an application specific network flow (block 420). In many embodiments, a stream level mapping table may be used to assign an application specific network flow to a packet. A stream level mapping table may contain a variety of entries which match a particular classification with an application specific network flow. In one embodiment, the stream level mapping table can contain 128 entries. Each entry maps the tuple corresponding with a packet to one of 16 application specific network flows for distinct control. In other embodiments, the stream level mapping table application specific network flows may have more or fewer entries or flows.

These application specific network flows may increase the ability to allocate different amounts of application infrastructure capacity to different applications by allowing the systems and methods to distinguish between packets belonging to different applications. In some embodiments, five basic application specific network flows under which an incoming packet may be grouped exist: (1) web traffic—the application infrastructure flow from the Internet to a web server; (2) application server traffic—the application infrastructure flow from a web server to an application server; (3) DB traffic—the application infrastructure flow from an application server to a database; (4) management traffic—the application infrastructure flow between application infrastructure components in application infrastructure 110 and control blade 210; and (5) other—all other application infrastructure flows which cannot be grouped under the previous four headings.

In one specific embodiment, actions may be assigned to a packet based on the application specific network flow with which it is associated. Actions may be composed of multiple non-contradictory instructions based on the importance of the application specific network flow. Specific actions may include drop, meter, or inject. A drop action may include dropping a packet as the application specific network flow associated with the packet is of low importance. A meter action may indicate that the network bandwidth and connection request rate of an application specific network flow is under analysis and the packet is to be tracked and observed. An inject action may indicate that the packet is to be given a certain priority or placed in a certain port group.

After the packet is associated with an application specific network flow, the packet may be routed depending on whether the packet is considered management traffic (block 440). If the packet is considered management traffic, it may be redirected for special processing.

Turning briefly now to FIG. 5, a flow diagram of how management traffic is processed is depicted in accordance with a non-limiting embodiment. When a determination is made that the incoming packet is management traffic (block 440), a determination whether this management packet was received from a central management component (block 560) may then be made. If the management packet was received from an application infrastructure component in application infrastructure 110 (“No” branch), it may be forwarded to a central management component (e.g., control blade 210) (block 550). Conversely, if the management packet was received from a central management component (“Yes” branch), the management packet may be routed to an agent on an application infrastructure component of application infrastructure 110 (block 570).

In one particular embodiment, when FPGA 330 determines the application specific network flow of the packet is associated with management traffic, the packet is redirected by a switch for special processing by CPU 320 on management blade 230. If a determination is made that the management packet originated from an application infrastructure component in application infrastructure 110 (block 560), CPU 320 may then forward this packet out through an internal management port or the management blade 230 to an internal management port on control blade 210 (block 550).

Similarly, when a packet arrives at an internal management port on management blade 230 from control blade 210 (block 560), it is routed to CPU 320 on management blade 230, and in turn redirected by CPU 320 through a switch to an appropriate egress port, which then may forward the packet to an agent on an application infrastructure component coupled to that egress port and resident in application infrastructure 110.

In one specific embodiment, management blade 230 may be coupled to control blade 210, via hub 220, and an application infrastructure separate from application infrastructure 110. This management infrastructure allows management packets to be communicated between management blade 230 and control blade 210 without placing additional stress on application infrastructure 110. Additionally, even if a problem exists in application infrastructure 110, this problem does not effect communication between control blade 210 and management blade 230.

Since all traffic (both management and application infrastructure content) intended for application infrastructure components in application infrastructure 110 passes through management blade 230, management blade 230 is able to more effectively manage and control these application infrastructure components by regulating the delivery of various packets as explained herein. More particularly, with regards to management traffic, when management blade 230 determines that a management packet is destined for a management agent local to an application infrastructure component in application infrastructure 110, management blade 230 may hold delivery of all other packets to this application infrastructure component until it has completed delivery of the management packet. In this manner, management packets may be prioritized and delivered to these application infrastructure components regardless of the volume and type of other traffic in application infrastructure 110. The delivery and existence of these management packets may alleviate problems in the application infrastructure by allowing application infrastructure components of the application infrastructure to be controlled and manipulated regardless of the type and volume of network or other traffic in application infrastructure 110. For example, as mentioned above, broadcast storms usually prevent delivery of communications to an application infrastructure component. The existence and prioritization of management packets may alleviate these broadcast storms in application infrastructure 110, as delivery of content packets originating with an application infrastructure component may be withheld until a management packet which alleviates the problem on the application infrastructure component is delivered to a management agent local to the application infrastructure component.

Moving on now to FIG. 6, if the incoming communication is not management traffic (block 440), a determination may be made whether the destination of the packet is local to management blade 230 (block 450). This assessment may be made by an analysis of various layers of an incoming packet. Management blade 230 may determine the IP address of the destination of the incoming packet, or the IP port destination of the incoming packet, by examining various layers of the incoming packet. In one embodiment, this examination is done by logic associated with a switch within management blade 230 or by FPGA 330.

Management blade 230 may be aware of the IP address and ports which may be accessed through egress ports coupled to management blade 230. If an incoming packet has an IP destination address or an IP port destination which may be accessed through a port coupled to management blade 230, (“yes” branch from block 450), the destination of the packet is local to management blade 230. Conversely, if the incoming packet contains an IP destination address or an IP port destination which cannot be accessed through a port coupled to the same management blade 230, the destination of the packet is remote to management blade 230. In certain embodiments, a switch in management blade 230 determines if the packet is destined for a local or remote egress port.

If the packet is destined for a port on another management blade 230, the packet may be forwarded to fabric blade 240 for delivery to that other management blade 230, which is local to the port for which the packet is destined (block 470). In one embodiment, if the packet is destined for a remote management blade 230 (“No” branch from block 450), the packet may be assigned a latency and a priority (block 460) based upon the application specific network flow with which it is associated. The packet may then be packaged into a fabric packet suitable for transmission to fabric blade 240. This fabric packet may then be forwarded on to fabric I/F 340 for delivery to local management blade 230 (block 470).

Fabric I/F 340 may determine which management blade 230 is local to the port for which the packet is destined and forward the fabric packet to local management blade 230. The fabric packet may be forwarded through fabric blades 240 according to its assigned latency and priority. The latency and priority of the fabric packet may determine how fabric blades 240 transmit the fabric packet, and in what order the fabric packet is to be forwarded through fabric blades 240. Once the fabric packet reaches local management blade 230 the fabric packet may be converted back to the original packet by FPGA 330.

In a particular embodiment, fabric blade 240 may use virtual lanes, virtual lane arbitration tables, and service levels to transmit packets between fabric blades 240 based upon their latency and priorities. Virtual lanes may be multiple independent data flows sharing the same physical link but utilizing separate buffering and flow control for each latency or priority. Embedded in each fabric I/F 340 hardware port may be an arbiter that controls usage of these links based on the latency and priority assigned different packets. Fabric blade 240 may utilize weighted fair queuing to dynamically allocate each packet a proportion of link bandwidth between fabric blades 240. These virtual lanes and weighted fair queuing can combine to improve fabric utilization, avoid deadlock, and provide differentiated service between packet types when transmitting a packet between management blades 230.

Once the packet has reached a local management blade, an application weighted early discard (AWRED) value may be calculated for the packet (block 480). This value helps management blade 230 deal with contention for a port, and corresponding transit queues which may form at these ports. Random Early Discard is a form of load shedding which is commonly known in the art, the goal of which is to preserve a minimum average queue length for the queues at ports on management blade 230. The end effect of this type of approach is to maintain some bounded latency for a packet arriving at management blade 230 and intended for an egress port on management blade 230.

In one particular embodiment, management blade 230 may calculate an AWRED value to influence which packets are discarded based on the application or component with which the packet is associated. Therefore, management blade 230 may calculate this AWRED value based upon a combination of contention level for the port for which the packet is destined, and a control value associated with the application stream or application specific network flow with which the packet is associated.

In one embodiment, this control mechanism may be a stream rate control, and its value a stream rate value. Each application specific network flow may have a distinct stream rate value. While the stream rate value may be a single number, the stream rate control may actually control two distinct aspects of the managed application environment.

The first aspect is control of the bandwidth available for specific links, including links associated with ports from the management blade 230 as well as links associated with outbound fabric I/F 340 between management blades 230. This methodology, in effect, presumes the bandwidth of a specific link on network 112 is a scarce resource. Thus, when contention occurs for a port, a queue of the packets waiting to be sent out the port and down the link would normally form. The stream rate control effectively allows determination of what packets from which application specific network streams get a greater or lesser percentage of the available bandwidth of that port and corresponding network link. Higher priority streams or packets get a greater percentage, and lower priority streams get a lesser percentage. Network links, especially those connected to managed components, are often not congested when the application load is transaction-based (such as an e-commerce application) rather than stream-based (such as for streaming video or voice-over-IP applications). Therefore, the specific benefit of this control will vary with application type and load.

The second aspect of this control mechanism uses the access to the egress port or network link as a surrogate for the remainder of the managed and controlled application infrastructure that sits behind it. By controlling which packets get prioritized at the egress to the port, the stream rate control also affects the mix of packets seen by a particular application infrastructure component connected to the egress port.

In one specific embodiment, the stream rate control value may correspond to a number of bytes which will be transmitted out an egress port and down a network link each second. The control value may be 0-19 where each value increments the specific number of bytes per second transmitted on a logarithmic scale to allow an improved degree of control over the number of bytes actually transmitted. In this particular embodiment, the correspondence may be as follows:

| Stream Rate | Allowed Bytes per |
|---|---|
| Control Value | Second for Link |
| 0 | 5000 |
| 1 | 7500 |
| 2 | 11,500 |
| 3 | 17,000 |
| 4 | 26,000 |
| 5 | 40,000 |
| 6 | 60,000 |
| 7 | 90,000 |
| 8 | 135,000 |
| 9 | 200,000 |
| 10 | 300,000 |
| 11 | 460,000 |
| 12 | 700,000 |
| 13 | 1,060,000 |
| 14 | 1,600,000 |
| 15 | 2,400,000 |
| 16 | 3,600,000 |
| 17 | 5,500,000 |
| 18 | 8,500,000 |
| 19 | No AWRED processing |

Note that not all of the activities described in FIGS. 4-6 are necessary, that an element within a specific activity may not be required, and that further activities may be performed in addition to those illustrated. Additionally, the order in which each of the activities is listed is not necessarily the order in which they are performed. After reading this specification, a person of ordinary skill in the art will be capable of determining which activities and orderings best suit any particular objective.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method of classifying a communication in an application infrastructure:
examining a packet;
classifying the packet as management data or content data; and
routing the packet based on the classification.

2. The method of claim 1, wherein the packet is classified based on a protocol, a source address, a destination address, a source port, a destination port, or any combination thereof.

3. The method of claim 2, wherein classifying the packet is accomplished using a stream label mapping table.

4. The method of claim 1, wherein routing the packet further comprises routing the packet to a management interface component.

5. The method of claim 4, wherein the packet gets routed over a management infrastructure.

6. The method of claim 1, wherein the packet is received from a management interface component.

7. The method of claim 6, wherein the packet is received over a management infrastructure.

8. The method of claim 7, wherein the packet is routed to an agent on an application infrastructure component.

9. The method of claim 7, further comprising blocking other traffic in the application infrastructure.

10. An apparatus for implementing the method of claim 1.

11. A data processing system readable medium having code for classifying a communication in an application infrastructure, wherein the code is embodied within the data processing system readable medium, the code comprising instructions for:
examining a packet;
classifying the packet as management data or content data; and
routing the packet based on the classification.

12. The data processing system readable medium of claim 11, wherein the packet is classified based on a protocol, a source address, a destination address, a source port, a destination port, or any combination thereof.

13. The data processing system readable medium of claim 12, wherein classifying the packet is accomplished using a stream label mapping table.

14. The data processing system readable medium of claim 11, wherein routing the packet further comprises routing the packet to a management interface component.

15. The data processing system readable medium of claim 14, wherein the packet gets routed over a management infrastructure.

16. The data processing system readable medium of claim 11, wherein the packet is received from a management interface component.

17. The data processing system readable medium of claim 16, wherein the packet is received over a management infrastructure.

18. The data processing system readable medium of claim 17, wherein the packet is routed to an agent on an application infrastructure component.

19. The data processing system readable medium of claim 17, further comprising instructions translatable for blocking other traffic in the application infrastructure.
